(19) United States
(12) Patent Application Publication
(10) Pub. No.: US 2020/0395996 A1
(43) Pub. Date: Dec. 17, 2020

(54) COMMUNICATION APPARATUS, COMMUNICATION SYSTEM, AND DISPLAY METHOD

(71) Applicant: NEC Corporation, Tokyo (JP)

(72) Inventor: Naoya NAKAYAMA, Tokyo (JP)

(73) Assignee: NEC Corporation, Tokyo (JP)

(21) Appl. No.: 16/902,320

(22) Filed: Jun. 16, 2020

(30) Foreign Application Priority Data
Jun. 17, 2019 (JP) 2019-111882

(51) Int. Cl. H04B 7/10; H01Q 21/24; H01Q 1/24; H04L 1/00

(52) U.S. Cl. CPC H04B 7/10; H04L 1/0003; H01Q 1/246; H01Q 21/24

(57) ABSTRACT

A communication apparatus capable of appropriately adjusting the direction of an antenna is provided. A communication apparatus 1 includes an antenna 2, a calculation unit 3, and an outdoor apparatus 4. The antenna 2 receives a radio wave from a station on the other end. The calculation unit 3 calculates propagation-path information about a condition of a propagation path by using the radio wave received by the antenna 2. The outdoor apparatus 4 is disposed near the antenna 2. The outdoor apparatus 4 displays received power and the calculated propagation-path information.

### INCORPORATION BY REFERENCE

This application is based upon and claims the benefit of priority from Japanese patent application No. 2019-111882, filed on Jun. 17, 2019, the disclosure of which is incorporated herein in its entirety by reference.

### TECHNICAL FIELD

The present disclosure relates to a communication apparatus, a communication system, and a display method.

### BACKGROUND ART

In antennas that are installed in satellite base stations and receive radio waves from satellites, or antennas that are used to connect radio base stations for mobile phones, the directions of their antenna beams are adjusted so that their reception levels are maximized when they receive radio waves from radio-wave generation sources. In connection with this technique, for example, Japanese Unexamined Patent Application Publication No. 2013-207633 discloses an antenna direction adjusting method for adjusting the direction of an antenna provided in a radio apparatus. In the antenna direction adjusting method disclosed in Japanese Unexamined Patent Application Publication No. 2013-207633, a reception electric-field strength of a signal received by an antenna is measured; a sound having a sound pattern or a sound frequency corresponding to the measured reception electric-field strength is output; and the direction of the antenna is adjusted, according to the output sound, to a direction in which the reception electric-field strength is increased. Further, Japanese Unexamined Patent Application Publication No. H7-66617 discloses an indicator for adjusting the direction of a satellite signal receiving antenna. The indicator for adjusting the direction of an antenna disclosed in Japanese Unexamined Patent Application Publication H7-66617 compares the level of an output of a detected satellite signal from an antenna, which successively changes while the direction of the antenna is being changed, with that of a peak value thereof and thereby determines whether or not they are the same or not, and displays information according to the result of the comparison and determination.

In general, in a radio transmission system, a data error could occur due to, for example, attenuation or fading in a radio propagation path. Further, in cross polarization multiplexing, it would be ideal if a transmitting antenna and a receiving antenna are installed in parallel to each other in order to minimize inter-polarization interference. However, it is difficult to arrange the transmitting antenna and the receiving antenna, which are installed far away from each other, in parallel to each other, and as a result inter-polarization interference could occur. Meanwhile, in the technique disclosed in the above-mentioned patent literature, since the direction of the antenna is adjusted according to only the reception strength, there is a possibility that the direction of the antenna cannot be appropriately adjusted when the above-described phenomenon occurs.

An example object of the present disclosure is to provide a communication apparatus, a communication system, and a display method capable of appropriately adjusting the direction of an antenna.

### SUMMARY

In a first example aspect, a communication apparatus includes: an antenna configured to receive a radio wave from a station on the other end; calculation means for calculating propagation-path information about a condition of a propagation path by using the radio wave received by the antenna; and an outdoor apparatus disposed near the antenna and configured to display received power and the calculated propagation-path information.

In another example aspect, a communication system includes: a communication apparatus including: an antenna configured to receive a radio wave from a station on the other end; calculation means for calculating propagation-path information about a condition of a propagation path by using the radio wave received by the antenna; and an outdoor apparatus disposed near the antenna and configured to display received power and the calculated propagation-path information; and the station on the other end configured to transmit the radio wave toward the communication apparatus.

In another example aspect, a display method includes: calculating propagation-path information about a condition of a propagation path by using a radio wave received by an antenna, the antenna being configured to receive the radio wave from a station on the other end; and displaying received power and the calculated propagation-path information in an outdoor apparatus disposed near the antenna.

According to the present disclosure, it is possible to provide a communication apparatus, a communication system, and a display method capable of appropriately adjusting the direction of an antenna.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows an outline of a communication apparatus according to an example embodiment of the present disclosure;

FIG. 2 shows a configuration of a communication apparatus according to a comparative example;

FIG. 3 shows a configuration of a communication apparatus according to a first example embodiment;

FIG. 4 shows a configuration of a communication system according to a second example embodiment;

FIG. 5 shows a configuration of a receiving station according to the second example embodiment in a detailed manner;

FIG. 6 is a diagram for explaining processes performed by a hard decision unit and an error-signal generation unit according to the second example embodiment;

FIG. 7 shows an example of information displayed by a propagation-path information display unit according to the second example embodiment;

FIG. 8 shows an example of information displayed by the propagation-path information display unit according to the second example embodiment;

FIG. 9 shows an example of information displayed by the propagation-path information display unit according to the second example embodiment;

FIG. 10 shows an example of information displayed by the propagation-path information display unit according to the second example embodiment;

FIG. 11 shows an example of information displayed by the propagation-path information display unit according to the second example embodiment;

FIG. 12 shows an example of information displayed by the propagation-path information display unit according to the second example embodiment;

FIG. 13 shows an example of information displayed by the propagation-path information display unit according to the second example embodiment;

FIG. 14 shows an example of information displayed by the propagation-path information display unit according to the second example embodiment;

FIG. 15 shows an example of information displayed by the propagation-path information display unit according to the second example embodiment;

FIG. 16 shows a flowchart for adjusting the direction of an antenna; and

FIG. 17 shows another example of a communication apparatus.

### EMBODIMENTS

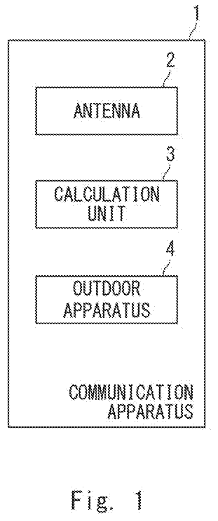

(Overview of Example Embodiment according to Present Disclosure) Prior to describing an example embodiment according to the present disclosure, an overview of the example embodiment according to the present disclosure will be described. FIG. 1 shows an outline of a communication apparatus 1 according to an example embodiment in accordance with the present disclosure. The communication apparatus 1 includes an antenna 2, a calculation unit 3, and an outdoor apparatus 4.

The antenna 2 receives radio waves (a signal) from a station on the other end (i.e., an opposite station, that is, a station with which the communication apparatus 1 communicates). The calculation unit 3 (the calculation means) calculates propagation-path information about the condition(s) of a propagation path by using the radio waves received by the antenna 2. In other words, the calculation unit 3 can calculate propagation-path information relating to a phenomenon(s) that could cause a failure in the propagation path by using the radio waves received by the antenna 2. The outdoor apparatus 4 is disposed near the antenna 2. The outdoor apparatus 4 displays received power and the calculated propagation-path information.

Note that the propagation-path information is, for example, information indicating at least one of a fading strength and cross-polarization discrimination. Therefore, the calculation unit 3 calculates cross-polarization discrimination information indicating cross-polarization discrimination. Further, the calculation unit 3 calculates fading strength information indicating a fading strength. Note that in a display method according to this example embodiment, the communication apparatus 1 calculates propagation-path information about the condition(s) of a propagation path by using radio waves received by the antenna that receives radio waves from the station on the other end (i.e., an opposite station, that is, the station with which the communication apparatus 1 communicates). Further, the communication apparatus 1 makes the outdoor apparatus 4 display the received power and the calculated propagation-path information.

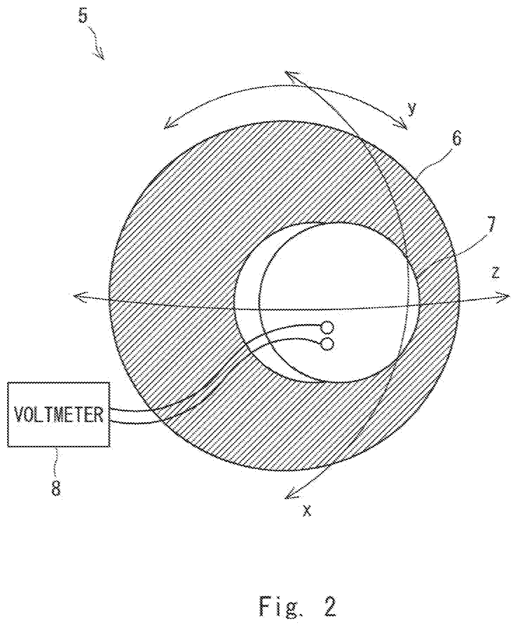

Effects of this example embodiment will be described hereinafter while comparing this example embodiment with a comparative example. FIG. 2 shows a configuration of a communication apparatus 5 according to a comparative example. The communication apparatus 5 according to the comparative example includes an antenna 6, an outdoor apparatus 7, and a voltmeter 8 for measuring received power. The outdoor apparatus 7 outputs a signal that is obtained by converting an average value of the power of a signal received by the antenna 6 into a voltage and outputs the obtained signal to the voltmeter 8. In the comparative example, an operator adjusts the direction of the antenna 6 by moving the antenna 6 in the x-, y- and z-directions as shown in FIG. 2 while observing the value of the voltmeter 8 so that the received power is increased (preferably it is maximized).

In a radio transmission system, a data error could occur due to, for example, attenuation or fading in a radio propagation path. Further, in cross polarization multiplexing, it would be ideal if a transmitting antenna and a receiving antenna are arranged in parallel to each other in order to minimize inter-polarization interference. However, it is difficult to install the transmitting antenna and the receiving antenna, which are installed far away from each other, in parallel to each other, and as a result cross-polarization discrimination XPD (Cross Polarization Discrimination) may deteriorate and inter-polarization interference could occur.

In a line-of-sight radio transmission system using a directional antenna as in the comparative example, when the method in which the direction of the antenna is adjusted while measuring received power is used, the antenna is usually adjusted to a direction in which the average received power is increased. However, when multipath fading occurs due to ground reflection or the like in the propagation path, an average data error rate may be reduced by adjusting the direction of the antenna to a direction in which the antenna is less likely to be affected by the multipath fading. This is because by directing the antenna to a direction in which the antenna can receive the direct wave while avoiding the reflected wave, the antenna is less likely to be affected by changes that occur due to the movements of natural/artificial objects in the propagation path. However, there has been a problem that it is difficult for an operator to check the occurrence of fading and the inter-polarization discrimination when the operator adjusts the direction of the antenna which is usually carried out in a high place.

In contrast to this, an operator who adjusts the direction of the antenna 2 can adjust it while checking the received power and the propagation-path information displayed in the outdoor apparatus 4. Specifically, the operator can adjust the direction of the antenna to a direction in which the fading strength is weak and the cross-polarization discrimination is high while maintaining the received power at such a level that substantially no symbol error occurs. As a result, it is possible to reduce the average data error rate in the radio transmission as compared with the case where the direction of the antenna is adjusted by using only the condition that the received power is high as an index as in the comparative example. Therefore, in the communication apparatus 1 according to this example embodiment, it is possible to appropriately adjust the direction of the antenna. Further, the direction of the antenna can also be appropriately adjusted by a communication system which includes the communication apparatus 1 and the station on the other end (i.e., an opposite station, that is, the station with which the communication apparatus 1 communicates). Further, the direction of the antenna can also be appropriately adjusted by a display method which is performed by the communication apparatus 1.

### First Example Embodiment

Example embodiments will be described hereinafter with reference to the drawings. For clarifying the description, the following description and the drawings have been partially omitted and simplified as appropriate. Further, the same symbols are assigned to the same elements throughout the drawings, and redundant explanations are omitted as necessary.

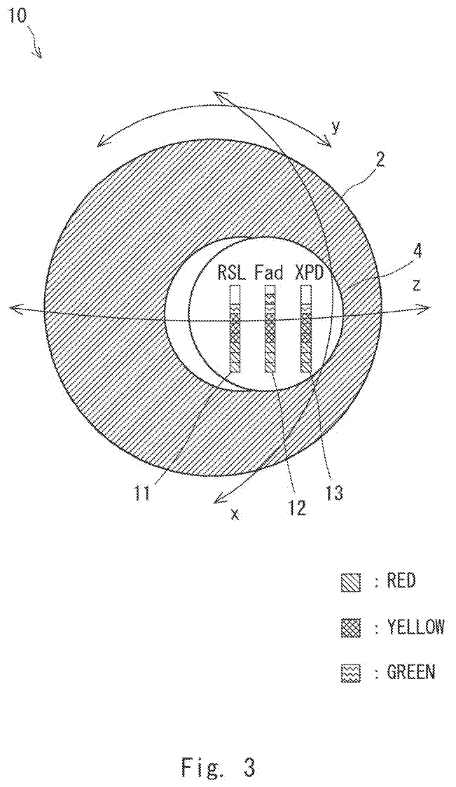

FIG. 3 shows a configuration of a communication apparatus 10 according to a first example embodiment. The communication apparatus 10 corresponds to the communication apparatus 1 shown in FIG. 1. The communication apparatus 10 includes an antenna 2 and an outdoor apparatus 4. However, the communication apparatus 10 does not need to be equipped with the voltmeter shown in FIG. 2. The outdoor apparatus 4 displays, on its surface, a strength of fading, cross-polarization discrimination, and received power for a signal (radio waves) received by the antenna 2 side by side. In this way, an operator can visually recognize the strength of fading, the cross-polarization discrimination, and the received power.

The outdoor apparatus 4 displays an RSL indicator 11, a Fad indicator 12, and an XPD indicator 13 side by side. The RSL indicator 11 indicates received power RSL (Received Signal Level). The Fad indicator 12 indicates a fading strength Fad (Fading). The XPD indicator 13 indicates cross-polarization discrimination XPD. Each of the RSL indicator 11, the Fad indicator 12, and the XPD indicator 13 includes red, yellow and green LEDs (Light Emitting Diodes). In the RSL indicator 11, the red, yellow and green LEDs are lighted when the received power is sufficiently higher than reference received power (threshold received power) at which a symbol error could occur. When the received power is close to the threshold received power, the red and yellow LEDs are lighted. When the received power is lower than that, only the red LEDs is lighted. Note that a threshold at which the yellow LEDs are lighted and a threshold at which the green LEDs are lighted may be determined in advance. The same applies to the Fad indicator 12 and the XPD indicator 13.

In the Fad indicator 12, red, yellow and green LEDs are lighted when the fading strength is sufficiently smaller than a predetermined threshold. When the fading strength is roughly equal to the threshold, the red and yellow LEDs are lighted. When the fading strength is sufficiently larger than the threshold, only the red LEDs are lighted.

In the XPD indicator 13, the red, yellow and green LEDs are lighted when the cross-polarization discrimination is sufficiently larger than a predetermined threshold. When the cross-polarization discrimination is roughly equal to the threshold, the red and yellow LEDs are lighted. When the cross-polarization discrimination is sufficiently smaller than the threshold, only the red LEDs are lighted.

An operator adjusts the direction of the antenna so that the red, yellow and green LEDs of all of the RSL indicator 11, the Fad indicator 12, and the XPD indicator 13 are lighted. In this way, it is possible to adjust the direction of the antenna to a direction in which the fading strength is low and the cross-polarization discrimination is high while maintaining the received power at such a level that substantially no symbol error occurs. As a result, it is possible to reduce the average data error rate as compared with the case where the direction of the antenna is adjusted by using only the condition that the received power is high as an index as in the comparative example.

Note that the method for displaying information on the surface of the outdoor apparatus 4 may be any other methods as long as a person (e.g., an operator) can recognize the displayed information. For example, numerical values representing the received power, the fading strength, and the cross-polarization discrimination may be displayed on a liquid crystal screen or the like. Alternatively, such numerical values may be converted into sounds and output from a speaker. That is, the expression “to display (the received power and the propagation-path information)” includes, in addition to visually displaying the received power and the propagation-path information (the fading strength and the cross-polarization discrimination), audibly outputting the received power and the propagation-path information. In other words, the expression “to display (the received power and the propagation-path information)” means outputting the received power and the propagation-path information so that an operator can recognize them.

### Second Example Embodiment

Next, a second example embodiment will be described. For clarifying the description, the following description and the drawings have been partially omitted and simplified as appropriate. Further, the same symbols are assigned to the same elements throughout the drawings, and redundant explanations are omitted as necessary. The second example embodiment is equivalent to the first example embodiment but is described in a more detailed manner.

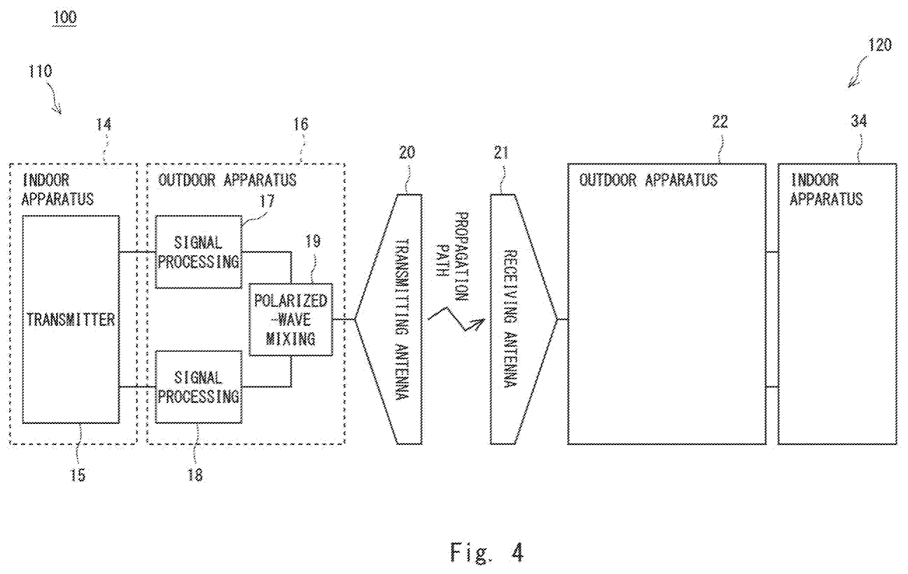

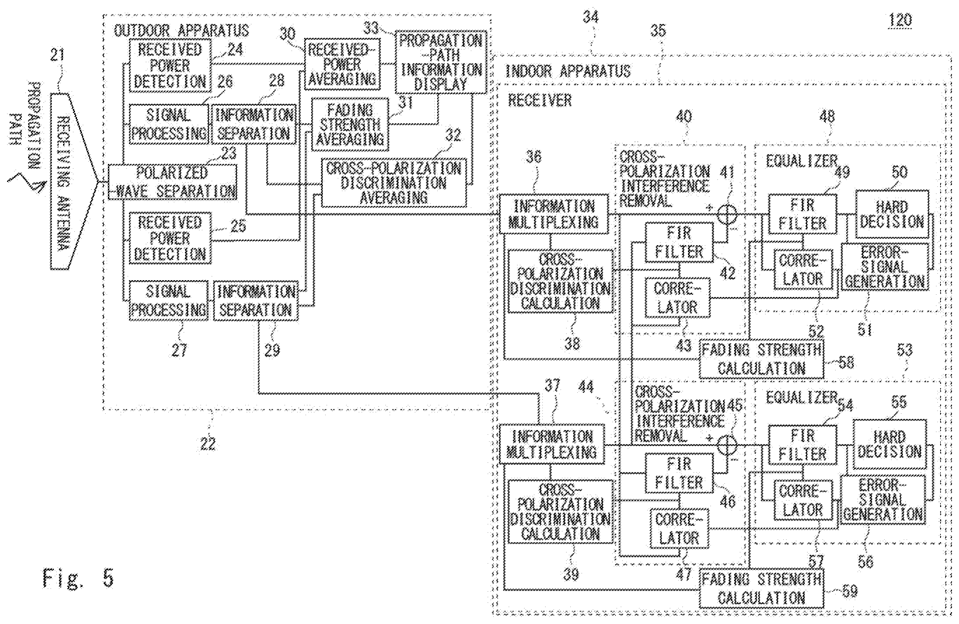

FIG. 4 shows a configuration of a communication system 100 according to the second example embodiment. The communication system 100 includes a transmitting station 110 and a receiving station 120. The transmitting station 110 corresponds to the station on the other end and the receiving station 120 corresponds to the communication apparatus 10. The transmitting station 110 includes an indoor apparatus 14, an outdoor apparatus 16, and a transmitting antenna 20. The receiving station 120 includes a receiving antenna 21, an outdoor apparatus 22, and an indoor apparatus 34. The receiving antenna 21 corresponds to the antenna 2 and the outdoor apparatus 22 corresponds to the outdoor apparatus 4. Further, the indoor apparatus 34 corresponds to the calculation unit 3. Note that some of the components of the outdoor apparatus 22 may also correspond to the calculation unit 3. Configurations of the outdoor apparatus 22 and the indoor apparatus 34 will be described later with reference to FIG. 5.

The indoor apparatus 14 includes a transmitter 15. The outdoor apparatus 16 includes signal processing units 17 and 18, and a polarized-wave mixing unit 19. The transmitter 15 outputs a transmission signal, which is to be multiplexed in each polarized wave, to the signal processing units 17 and 18. The signal processing units 17 and 18 perform various kinds of processing such as power amplification and conversion from an intermediate frequency (IF: Intermediate Frequency) into a radio frequency (RF: Radio Frequency) for the transmission signal output from the transmitter 15. The polarized-wave mixing unit 19 receives the processed signal from the signal processing units 17 and 18, and generates horizontally polarized waves and vertically polarized waves. Then, the transmitting antenna 20 transmits a signal (radio waves) composed of horizontally polarized waves and vertically polarized waves. The signal transmitted from the transmitting antenna 20 undergoes various effects such as attenuation, cross-polarization interference, and fading in a propagation path between the transmitting antenna 20 and the receiving antenna 21, and then is received by the receiving antenna 21.

FIG. 5 shows a configuration of the receiving station 120 according to the second example embodiment in a detailed manner. The outdoor apparatus 22 includes a polarized-wave separation unit 23, received-power detection units 24 and 25, signal processing units 26 and 27, information separation units 28 and 29, a received-power averaging unit 30, a fading strength averaging unit 31, a cross-polarization discrimination averaging unit 32, and a propagation-path information display unit 33. The indoor apparatus 34 includes a receiver 35. The receiver 35 includes information multiplexing units 36 and 37, cross-polarization discrimination calculation units 38 and 39, cross-polarization interference removal units 40 and 44, equalizers 48 and 53, and fading strength calculation units 58 and 59. The cross-polarization interference removal unit 40 includes an adder 41, an FIR filter 42, and a correlator 43. The cross-polarization interference removal unit 44 includes an adder 45, an FIR filter 46, and a correlator 47. The equalizer 48 includes an FIR filter 49, a hard decision unit 50, an error-signal generation unit 51, and a correlator 52. The equalizer 53 includes an FIR filter 54, a hard decision unit 55, an error-signal generation unit 56, and a correlator 57. Note that at least the received-power averaging unit 30, the fading strength averaging unit 31, and the cross-polarization discrimination averaging unit 32 can correspond to the calculation unit 3.

The polarized-wave separation unit 23 separates a signal received by the receiving antenna 21 into horizontally polarized waves and vertically polarized waves. The polarized-wave separation unit 23 outputs a signal of one of the horizontally and vertically polarized waves to the received-power detection unit 24 and the signal processing unit 26, and outputs a signal of the other polarized waves to the received power detection unit 25 and the signal processing unit 27. The received-power detection units 24 and 25 calculate the power of the received signals and output received power information indicating the calculated power to the received-power averaging unit 30. The received-power averaging unit 30 calculates an average value of the received power information received from the received power detecting units 24 and 25, and outputs the calculated average value to the propagation-path information display unit 33. The propagation-path information display unit 33 displays the received power in a certain manner as described later.

The signal processing units 26 and 27 perform various kinds of processing such as power amplification and conversion from a radio frequency to an intermediate frequency for the received signal. The signal processing unit 26 outputs the processed signal to the information separation unit 28. The signal processing unit 27 outputs the processed signal to the information separation unit 29. The information separation unit 28 outputs the received signal to the information multiplexing unit 36. The information separation unit 29 outputs the received signal to the information multiplexing unit 37.

Since the configurations for performing signal processing for respective polarized waves in the receiver 35 are substantially the same as each other, only the configuration for processing one of the polarized waves will be described hereinafter. The signal input to the information multiplexing unit 36 of the receiver 35 is output to the adder 41 included in the cross-polarization interference removal unit 40 and to the FIR (Finite Impulse Response) filter 46 and the correlator 47 included in the cross-polarization interference removal unit 44.

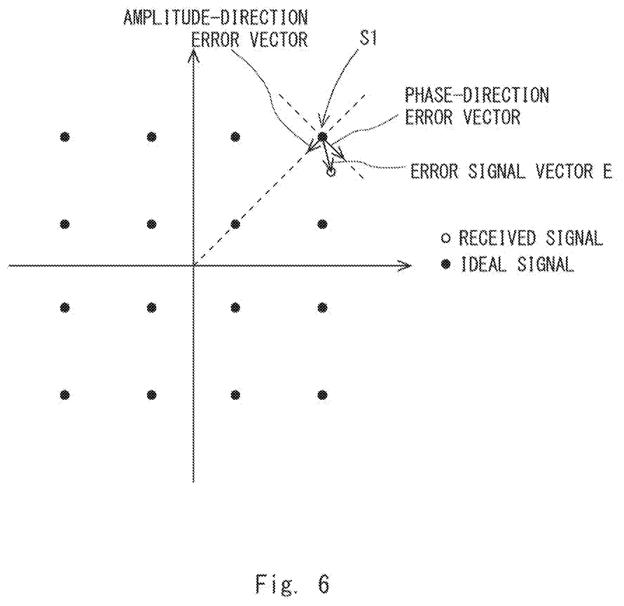

After removing cross-polarization interference from the signal, the adder 41 outputs the signal to the FIR filter 49 included in the equalizer 48. The FIR filter 49 removes inter-symbol interference caused by fading and the like. Specifically, the FIR filter 49 removes the inter-symbol interference by performing convolution calculation of the output from the adder 41 and a tap coefficient. Note that the tap coefficient is calculated by the correlator 52 (which will be described later). After that, the FIR filter 49 outputs the signal to the hard decision unit 50 and the error-signal generation unit 51. The hard decision unit 50 and the error-signal generation unit 51 generate an error signal. FIG. 6 is a diagram for explaining processes performed by the hard decision unit 50 and the error-signal generation unit 51 according to the second example embodiment. FIG. 6 shows a constellation of 16 QAM (Quadrature Amplitude Modulation). The hard decision unit 50 determines that an ideal signal (indicate by an arrow 51) closest to the received signal is the transmission signal. The error signal generation unit 51 calculates an error signal vector E (an error signal) from the ideal signal (the transmission signal) and the received signal. Then, the error signal generation unit 51 calculates an error signal by using a vector in the amplitude direction of the error signal vector E as an amplitude-direction error vector and using a vector in the phase direction of the error signal vector E as a phase-direction error vector.

The error signal generation unit 51 (FIG. 5) outputs the generated error signal to the correlator 52 included in the equalizer 48 and the correlator 43 included in the cross-polarization interference removal unit 40. The correlator 52 included in the equalizer 48 calculates a correlation between the output of the adder 41 included in the cross-polarization interference removal unit 40 and the error signal, i.e., calculates a tap coefficient. The correlator 52 outputs the tap coefficient to the FIR filter 49 and the fading strength calculation unit 58. The correlator 43 included in the cross-polarization interference removal unit 40 calculates a correlation between the received signal of the other polarized waves output from the information multiplexing unit 37 and the error signal of the own polarized waves, i.e., calculates a tap coefficient. The correlator 43 outputs the tap coefficient to the FIR filter 42 and the cross-polarization discrimination calculation unit 38. The FIR filter 42 performs convolution calculation of the received signal of the other polarized waves output from the information multiplexing section 37 and the tap coefficient. As a result, the cross-polarization interference is removed in the adder 41.

The fading strength calculation unit 58 calculates a total value of the magnitudes of the received tap coefficients as fading strength information. The fading strength calculation unit 58 outputs the calculated fading strength information to the information multiplexing unit 36. The cross-polarization discrimination calculation unit 38 calculates the inverse of the total value of the magnitudes of the received tap coefficients as cross-polarization discrimination information. The cross-polarization discrimination calculation unit 38 outputs the calculated cross-polarization discrimination information to the information multiplexing unit 36. The information multiplexing unit 36 outputs the fading strength information and the cross-polarization discrimination information to the information separation unit 28 included in the outdoor apparatus 22.

In the above description, the components that process one of the polarized waves in the receiver 35 have been described. The other polarized waves are processed by the corresponding components and therefore the descriptions thereof are omitted.

Each of the information separation units 28 and 29 included in the outdoor apparatus 22 outputs the received fading strength information to the fading strength averaging unit 31. The fading strength averaging unit 31 averages the fading strength information received from the information separation units 28 and 29. The fading strength averaging unit 31 outputs the averaged fading strength information to the propagation-path information display unit 33. The propagation-path information display unit 33 displays the fading strength in a certain manner as described later.

Each of the information separation units 28 and 29 output the received cross-polarization discrimination information to the cross-polarization discrimination averaging unit 32. The cross-polarization discrimination averaging unit 32 averages the cross-polarization discrimination information received from the information separation units 28 and 29. The cross-polarization discrimination averaging unit 32 outputs the averaged cross-polarization discrimination information to the propagation-path information display unit 33. The propagation-path information display unit 33 displays the cross-polarization discrimination in a certain manner as described later.

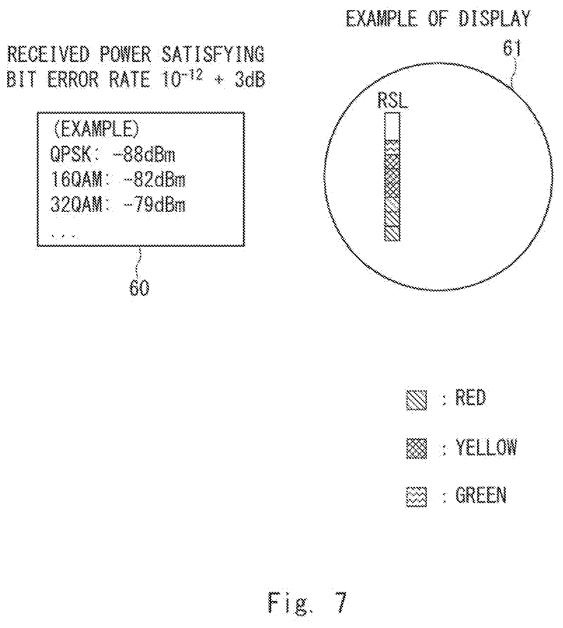

FIGS. 7 to 15 show examples of information displayed by the propagation-path information display unit 33 according to the second example embodiment. FIGS. 7 to 9 show that information displayed in the propagation-path information display unit 33 changes according to how much the received power indicated by the received power information input to the propagation-path information display unit 33 is higher than reference received power (threshold received power) at which a predetermined bit error rate is satisfied. Although the predetermined bit error rate is 10⁻¹² in the following example, the bit error rate that should be satisfied may be arbitrarily determined. FIG. 7 shows an example 61 of displayed information when the input received power information has a value 60 which is 3 dB higher than the reference received power at which the predetermined bit error rate 10⁻¹² is satisfied. When the received power indicated by the input received power information is 3 dB higher than the reference received power at which the predetermined bit error rate 10⁻¹² is satisfied, the red, yellow and green LEDs are lighted. In the example shown in FIG. 7, when the modulation scheme is QPSK (Quadrature Phase Shift Keying) and the received power information is −88 dBm, the red, yellow and green LEDs are lighted. Further, when the modulation scheme is 16 QAM and the received power information is −82 dBm, the red, yellow and green LEDs are lighted. Further, when the modulation scheme is 32 QAM and the received power information is −79 dBm, the red, yellow and green LEDs are lighted.

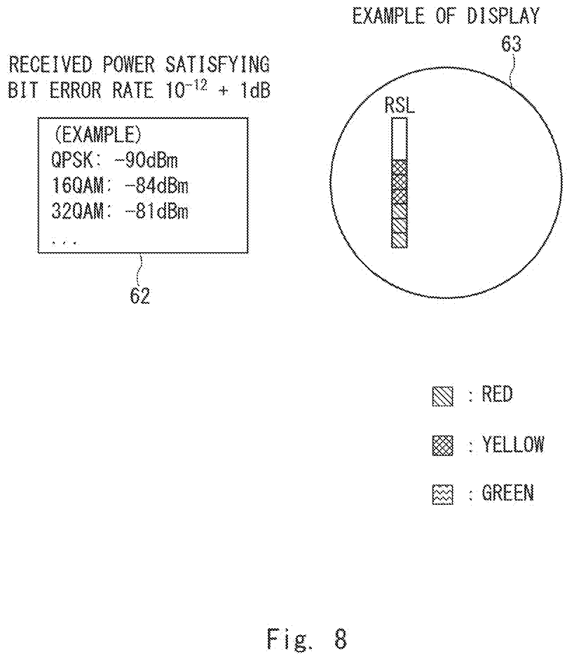

FIG. 8 shows an example 63 of displayed information when the input received power information has a value 62 which is 1 dB higher than the reference received power at which the predetermined bit error rate 10⁻¹² is satisfied. When the received power indicated by the input received power information is 1 dB higher than the received power at which the predetermined bit error rate 10⁻¹² is satisfied, the red and yellow LEDs are lighted. In the example shown in FIG. 8, when the modulation scheme is QPSK and the received power information is −90 dBm, the red and yellow LEDs are lighted. Further, when the modulation scheme is 16 QAM and the received power information is −84 dBm, the red and yellow LEDs are lighted. Further, when the modulation scheme is 32 QAM and the received power information is −81 dBm, the red and yellow LEDs are lighted.

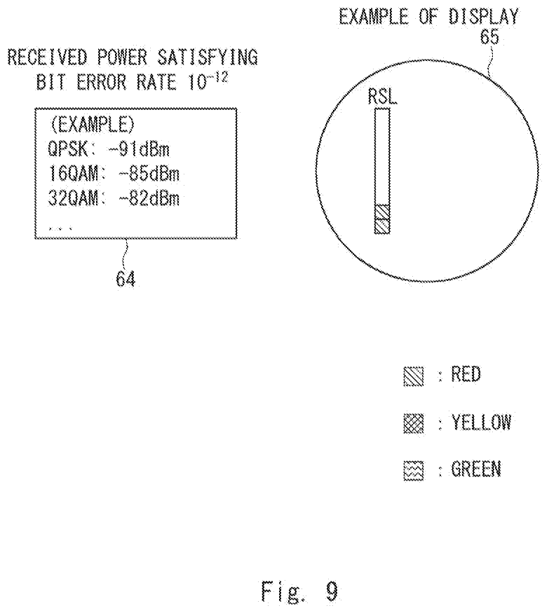

FIG. 9 shows an example 65 of displayed information when the input received power information has a value 64 which is equal to the reference received power at which the predetermined bit error rate 10⁻¹² is satisfied. When the received power indicated by the input received power information is equal to the received power at which the predetermined bit error rate 10⁻¹² is satisfied, the red LEDs are lighted. In the example shown in FIG. 9, when the modulation scheme is QPSK and the received power information is −91 dBm, the red LEDs are lighted.

Further, when the modulation scheme is 16 QAM and the received power information is −85 dBm, the red LEDs are lighted. Further, when the modulation scheme is 32 QAM and the received power information is −82 dBm, the red LEDs are lighted.

Note that in the indoor apparatus 34 (or the outdoor apparatus 22), data in which a condition(s) satisfying a predetermined bit error rate is defined for each combination of the modulation scheme and the received power is stored in a memory (not shown) in advance. This data can be acquired, for example, by making the transmitting station 110 transmit signals while changing the transmission power in each of the modulation schemes and making the receiving station 120 measuring bit error rates at the same time before the antenna is adjusted (before the operation is started). In this case, the larger the number of multi-values of the modulation scheme is, the higher received power is required to satisfy the same bit error rate. Therefore, the larger the number of modulation multi-values is, the more strictly the condition that satisfies the predetermined bit error rate is set. In the examples shown in FIGS. 7 to 9, the condition that satisfies the predetermined bit error rate when the modulation scheme is QPSK is set as “Received Power Information: −91 dBm”. Further, the condition that satisfies the predetermined bit error rate when the modulation scheme is 16 QAM is set to “Received Power Information: −85 dBm”. Further, the condition that satisfies the predetermined bit error rate when the modulation scheme is 32 QAM is set to “Received Power Information: −82 dBm”.

Therefore, the outdoor apparatus 22 displays received power based on the condition that satisfies the predetermined bit error rate defined for each combination of the modulation scheme and the received power. In this way, the propagation-path information display unit 33 can display different information according to the modulation scheme even when the received power is the same. For example, in the case where the received power is −84 dBm, when the modulation scheme is QPSK, the red, yellow and green LEDs are lighted, and when the modulation scheme is 16 QAM, the red and yellow LEDs are lighted. Further, when the modulation scheme is 32 QAM, the red LEDs are lighted. As described above, even when the received power is the same, displayed information changes according to the modulation scheme, so that an operator can appropriately determine whether the received power is satisfactory in the current modulation scheme. Therefore, the direction of the antenna can be appropriately adjusted.

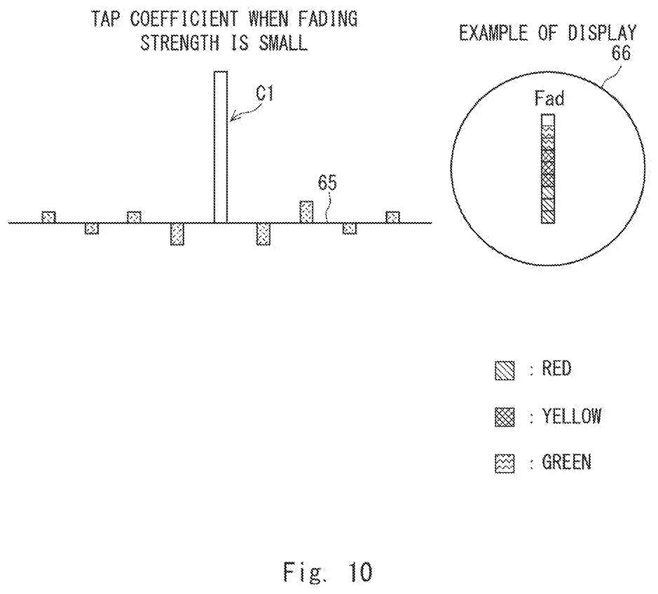

FIGS. 10 to 12 show that information displayed in the propagation-path information display unit 33 changes according to the magnitude of the fading strength indicated by the fading strength information input to the propagation-path information display unit 33. The propagation-path information display unit 33 (or other components) may determine the magnitude (large, intermediate or small) of the fading strength indicated by the fading strength information by comparing the total value of the tap coefficients with a predetermined threshold. The propagation-path information display unit 33 may display the fading strength information according to the result of the determination.

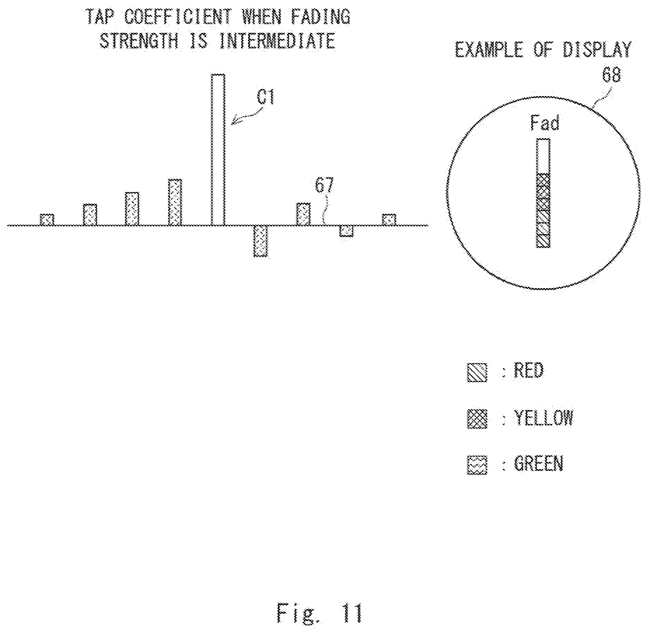

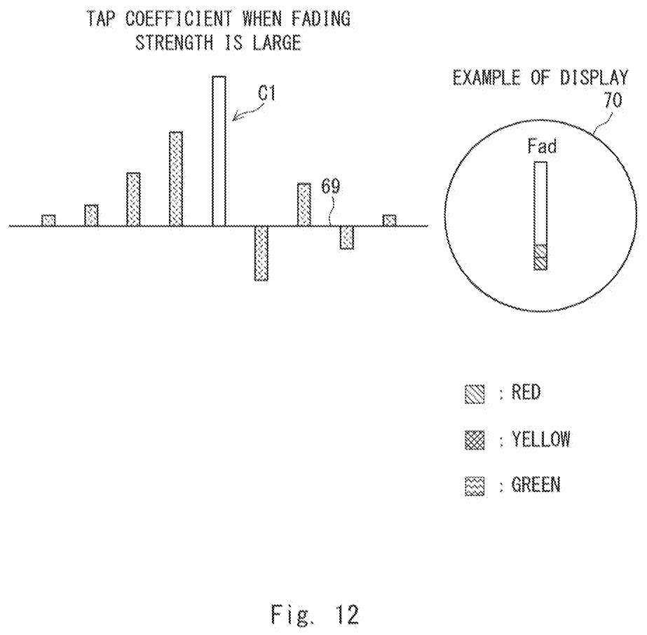

FIG. 10 shows tap coefficients 65 and an example 66 of displayed information when the fading strength indicated by the fading strength information is small. In this case, since the fading strength is sufficiently smaller than the predetermined threshold, the red, yellow and green LEDs are lighted. FIG. 11 shows tap coefficients 67 and an example 68 of displayed information when the fading strength indicated by the fading strength information is intermediate. In this case, since the fading strength is roughly equal to the threshold, the red and yellow LEDs are lighted. FIG. 12 shows tap coefficients 69 and an example 70 of displayed information when the fading strength indicated by the fading strength information is large. In this case, since the fading strength is sufficiently larger than the threshold, only the red LEDs are lighted.

Note that in FIGS. 10 to 12, the tap coefficients at the centers of the equalizers 48 and 53 shown in FIG. 5 are fixed. Further, the tap coefficient at the center (indicated by an arrow CO is a coefficient for making the received signal itself (the signal desired to be received) pass through the FIR filter, and the tap coefficients other than the tap coefficient at the center indicate interference components. That is, in an ideal propagation path in which no inter-symbol interference occurs, the tap coefficients other than the tap coefficient at the center are zero. Therefore, as shown in FIGS. 10 to 12, the fading strength calculation units 58 and 59 shown in FIG. 5 calculate the fading strength information based on the sum total of the tap coefficients other than the tap coefficient at the center. Note that the fading strength calculation units 58 and 59 may calculate the fading strength information based on the ratio of the sum total of the tap coefficients other than the tap coefficient at the center to the tap coefficient at the center.

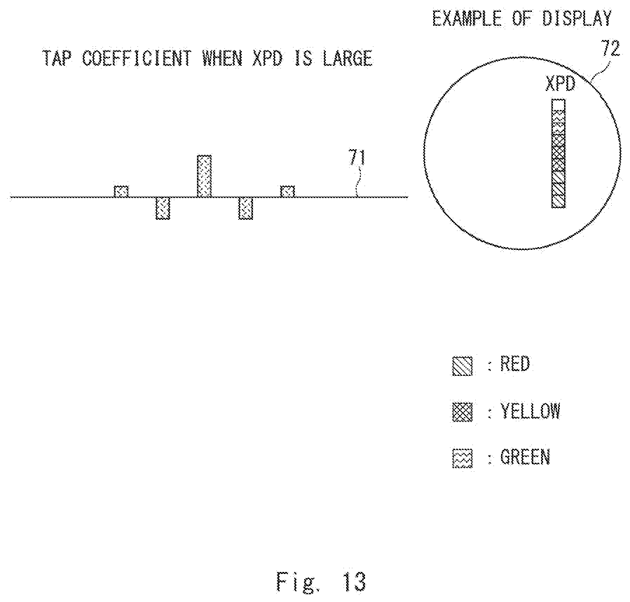

FIGS. 13 to 15 show that information displayed in the propagation-path information display unit 33 changes according to the magnitude of the cross-polarization discrimination indicated by the cross-polarization discrimination information input to the propagation-path information display unit 33. The propagation-path information display unit 33 (or other components) may determine the magnitude (large, intermediate or small) of the cross-polarization discrimination indicated by the cross-polarization discrimination information by comparing the inverse of the total value of the tap coefficients with a predetermined threshold. The propagation-path information display unit 33 may display the cross-polarization discrimination information according to the result of the determination.

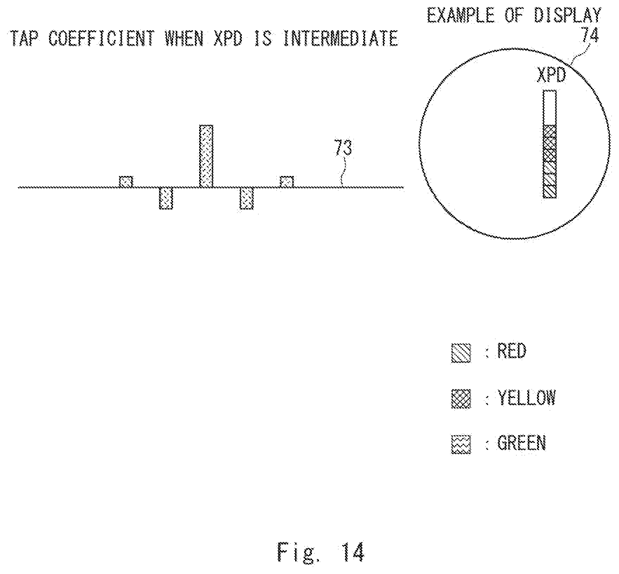

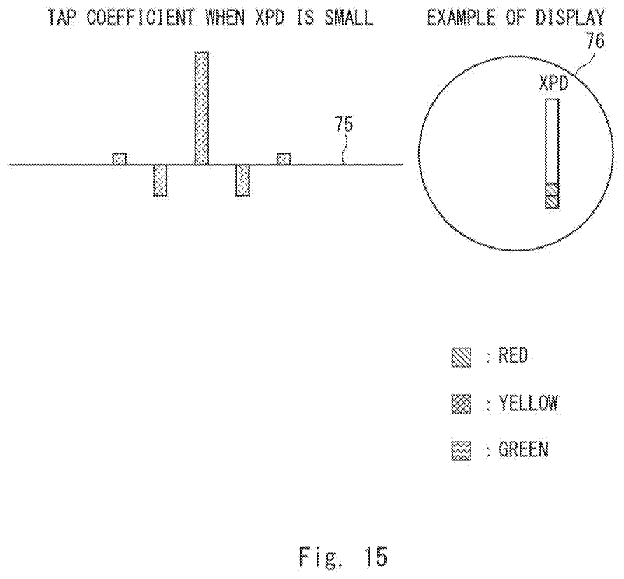

FIG. 13 shows tap coefficients 71 and an example 72 of displayed information when the cross-polarization discrimination indicated by the cross-polarization discrimination information is large. In this case, since the cross-polarization discrimination is sufficiently larger than the predetermined threshold, the red, yellow and green LEDs are lighted. FIG. 14 shows tap coefficients 73 and an example 74 of displayed information when the cross-polarization discrimination indicated by the cross-polarization discrimination information is intermediate. In this case, since the cross-polarization discrimination is roughly equal to the threshold, the red and yellow LEDs are lighted. FIG. 15 shows tap coefficients 75 and an example 76 of displayed information when the cross-polarization discrimination indicated by the cross-polarization discrimination information is small. In this case, since the cross-polarization discrimination is sufficiently smaller than the threshold, only the red LEDs are lighted.

Note that in general, the cross-polarization discrimination indicates that the interference is small when its numerical value is high, and indicates that the interference is large when its numerical value is low. Further, the tap coefficient indicates an interference component. That is, when an ideal antenna can be installed in an ideal manner so that no interference is caused by other polarized waves, all the tap coefficients become zero. Therefore, when the sum total of the tap coefficients is large, the interference level is large and hence the cross-polarization discrimination is low. On the other hand, when the sum total of the tap coefficients is small, the interference level is small and hence the cross-polarization discrimination is high. Therefore, the cross-polarization discrimination calculation units 38 and 39 can calculate the cross-polarization discrimination information by the inverse of the sum total of the tap coefficients. That is, when the inverse of the sum total of the tap coefficients is larger than the predetermined threshold, the cross-polarization discrimination calculation units 38 and 39 determine that the cross-polarization discrimination indicted by the cross-polarization discrimination information is large. Further, when the inverse of the sum total of the tap coefficients is intermediate as compared to the predetermined threshold, the cross-polarization discrimination calculation units 38 and 39 determine that the cross-polarization discrimination indicted by the cross-polarization discrimination information is intermediate. Further, when the inverse of the sum total of the tap coefficients is smaller than the predetermined threshold, the cross-polarization discrimination calculation units 38 and 39 determine that the cross-polarization discrimination indicted by the cross-polarization discrimination information is small.

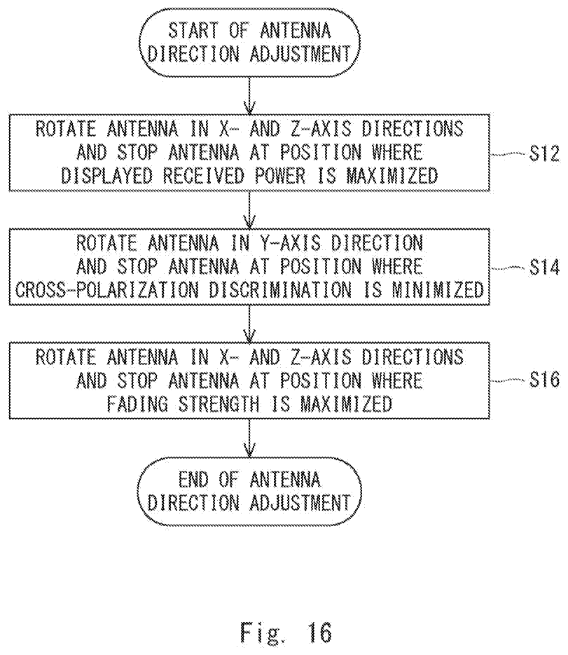

FIG. 16 is a flowchart for adjusting the direction of an antenna. Note that “x-axis”, “y-axis” and “z-axis” in the flowchart indicate directions x, y and z, respectively, in which the antenna shown in FIG. 3 is moved. Firstly, an operator moves the antenna 2 (the receiving antenna 21) in the x- and z-axis directions and stops the antenna 2 at a position where the received power displayed in the propagation-path information display unit 33 is maximized (step S12). In this way, the receiving antenna can be roughly directed toward the transmitting antenna.

Next, the operator moves the antenna 2 in the y-axis direction and stops the antenna 2 at a position where the cross-polarization discrimination displayed in the propagation-path information display unit 33 is maximized, i.e., at a position where the cross-polarization interference is minimized (step S14). Then, the operator moves the antenna 2 in the x- and z-axis directions and stops the antenna 2 at a position where the fading strength displayed in the propagation-path information display unit 33 is minimized (step S16).

Through the above-described procedure, the operator can adjust the direction of the antenna while referring to the information about the fading strength, the cross-polarization discrimination, and the received power displayed in the outdoor apparatus. In this way, it is possible to adjust the direction of the antenna to a direction in which the fading strength is low and the cross-polarization discrimination is high while maintaining the received power at such a level that substantially no symbol error occurs. Therefore, the average data error rate can be reduced.

Further, the operator can recognize the received power at such a level that substantially no symbol error occurs by using the outdoor apparatus. Therefore, it is possible to taken this received power into account in the adjustment of the antenna in the work site. Further, the operator can recognize the fading strength by using the outdoor apparatus. Therefore, it is possible to taken the fading strength into account in the adjustment of the antenna in the work site. Further, the operator can recognize the cross-polarization discrimination by using the outdoor apparatus. Therefore, it is possible to take the cross-polarization discrimination into account in the adjustment of the antenna in the work site. Further, owing to the above-described effects, it is possible to reduce the average data error rate as compared to the case where the direction of the antenna is adjusted by using only the condition that the received power is high.

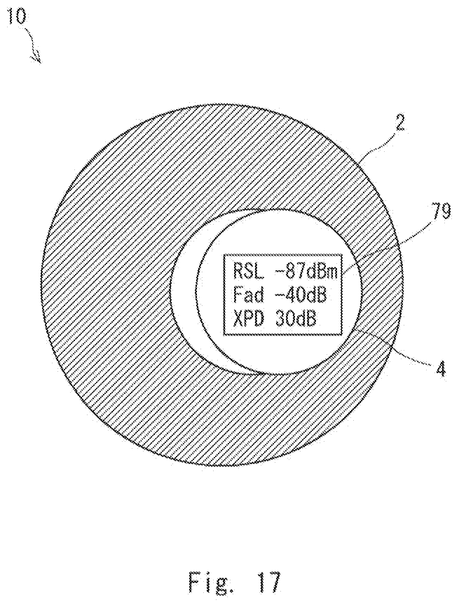

FIG. 17 shows another example of the communication apparatus 10. The communication apparatus 10 shown in FIG. 17 corresponds to the communication apparatus 1 shown in FIG. 1. The communication apparatus 10 includes an antenna 2 and an outdoor apparatus 4. The outdoor apparatus 4 displays information on a liquid crystal screen 79, instead of using LEDs. The liquid crystal screen 79 displays numerical values representing the received power, the fading strength, and the cross-polarization discrimination. The above-described effects can also be obtained by using this configuration. Further, the outdoor apparatus 4 may output sounds representing the received power and the propagation-path information through a speaker or the like.

Note that the color of each numerical value in FIG. 17 may be changed according to the difference from the threshold. For example, when the receive power is sufficiently higher than the threshold receive power, the numerical value of the RSL may be displayed in green. When the receive power is close to the threshold receive power, the numerical value of the RSL may be displayed in yellow. When the received power is lower than that, the numerical value of the RSL may be displayed in red. Further, when the fading strength is sufficiently smaller than the predetermined threshold, the numerical value representing the fading strength may be displayed in green. When the fading strength is roughly equal to the threshold, the numerical value representing the fading strength may be displayed in yellow. When the fading strength is sufficiently larger than the threshold, the numerical value representing the fading strength may be displayed in red. Further, when the cross-polarization discrimination is sufficiently larger than the predetermined threshold, the numerical value representing the cross-polarization discrimination may be displayed in green. When the cross-polarization discrimination is roughly equal to the threshold, the numerical value representing the cross-polarization discrimination may be displayed in yellow. When the cross-polarization discrimination is sufficiently smaller than the threshold, the numerical value representing the cross-polarization discrimination may be displayed in red.

### Modified Example

Note that the present disclosure is not limited to the above-described example embodiments and may be modified as appropriate without departing from the spirit and scope of the present disclosure. For example, the order in the flowchart shown in FIG. 16 can be changed as appropriate.

Further, although the fading strength is calculated by using the FIR filter (the transversal filter) in the above-described example embodiments, the present disclosure is not limited to such a configuration. The fading strength may be estimated from a pilot signal whose phase and amplitude are known in the receiver.

Further, at least one of the functions of the indoor apparatus 34 shown in FIG. 5 may be incorporated into those of the outdoor apparatus 22. Further, at least one of the functions of the outdoor apparatus 22 shown in FIG. 5 may be incorporated into those of the indoor apparatus 34. Further, in FIG. 5, some functions including that of the propagation-path information display unit 33 may be incorporated into an external apparatus connected to the outdoor apparatus 22. In this case, the “outdoor apparatus” may also include the external apparatus.

Further, although the cross-polarization discrimination information is displayed as propagation-path information in the above-described example embodiments, the present disclosure is not limited to such a configuration. The outdoor apparatus may display interference between radio channels instead of or in addition to the cross-polarization interference. For example, in a MIMO (Multiple Input Multiple Output) scheme using a plurality of antennas, interference between antennas may be estimated and the estimated interference between the antennas may be displayed.

Further, the received power, the fading strength, and the cross-polarization discrimination are displayed in different colors according to their magnitudes in the above-described example embodiments, the present disclosure is not limited to such a configuration. The expression by which the magnitudes of the received power, the fading strength, and the cross-polarization discrimination are indicated is not limited to the expression using colors. The expression by which the magnitudes of the received power, the fading strength, and the cross-polarization discrimination are indicated may be, for example, an expression using a gray scale (e.g., a gray scale in black) or an expression using a plurality of types of patterns. Further, when the received power and the like are indicated by sounds, the volume of the sound may be increased as the received power is increased. That is, the expression may be any expression by which the magnitude of the received power or the like can be distinguished so that an operator or the like can perceive (i.e., recognize) the magnitude.

Although the present disclosure is described as a hardware configuration in the above-described example embodiments, the present disclosure is not limited to the hardware configurations. In the present disclosure, the processes in each circuit in the communication apparatus can also be implemented by causing a CPU (Central Processing Unit) to execute a computer program.

In the above-described examples, the program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope according to the present disclosure as defined by the claims.

The whole or part of the example embodiments disclosed above can be described as, but not limited to, the following supplementary notes.

(Supplementary Note 1)

A communication apparatus comprising:

an antenna configured to receive a radio wave from a station on the other end;

calculation means for calculating propagation-path information about a condition of a propagation path by using the radio wave received by the antenna; and

an outdoor apparatus disposed near the antenna and configured to display received power and the calculated propagation-path information.

(Supplementary Note 2)

The communication apparatus described in Supplementary note 1, wherein

the calculation means calculates cross-polarization discrimination information indicating cross-polarization discrimination, and

the outdoor apparatus displays the cross-polarization discrimination information.

(Supplementary Note 3)

The communication apparatus described in Supplementary note 2, wherein the outdoor apparatus displays the cross-polarization discrimination information in such a manner that a way of expression of the cross-polarization discrimination information changes according to magnitude of the cross-polarization discrimination indicated thereby.

(Supplementary Note 4)

The communication apparatus described in any one of Supplementary notes 1 to 3, wherein

the calculation means calculates fading strength information indicating a fading strength, and

the outdoor apparatus displays the fading strength information.

(Supplementary Note 5)

The communication apparatus described in Supplementary note 4, wherein the outdoor apparatus displays the fading strength information in such a manner that a way of expression of the fading strength information changes according to magnitude of the fading strength indicated thereby.

(Supplementary Note 6)

The outdoor apparatus described in Supplementary note 2 or 3, wherein

the calculation means calculates fading strength information indicating a fading strength, and

the outdoor apparatus displays the received power, the cross-polarization discrimination information, and the fading strength information side by side.

(Supplementary Note 7)

The communication apparatus described in any one of Supplementary notes 1 to 6, wherein the outdoor apparatus displays the received power based on a condition that satisfies a predetermined bit error rate defined for each combination of a modulation scheme and the received power.

(Supplementary Note 8)

A communication system comprising:

a communication apparatus described in any one of Supplementary notes 1 to 7; and

a station on the other end configured to transmit a radio wave toward the communication apparatus.

(Supplementary Note 9)

A display method comprising:

calculating propagation-path information about a condition of a propagation path by using a radio wave received by an antenna, the antenna being configured to receive the radio wave from a station on the other end; and

displaying received power and the calculated propagation-path information in an outdoor apparatus disposed near the antenna.

(Supplementary Note 10)

The display method described in Supplementary note 9, wherein

cross-polarization discrimination information indicating cross-polarization discrimination is calculated, and

the cross-polarization discrimination information is displayed in the outdoor apparatus.

(Supplementary Note 11)

The display method described in Supplementary note 10, wherein the cross-polarization discrimination information is displayed in the outdoor apparatus in such a manner that a way of expression of the cross-polarization discrimination information changes according to magnitude of the cross-polarization discrimination indicated thereby.

(Supplementary Note 12)

The display method described in any one of Supplementary notes 9 to 11, wherein

fading strength information indicating a fading strength is calculated, and

the fading strength information is displayed in the outdoor apparatus.

(Supplementary Note 13)

The display method described in Supplementary note 12, wherein the fading strength information is displayed in the outdoor apparatus in such a manner that a way of expression of the fading strength information changes according to magnitude of the fading strength indicated thereby.

(Supplementary Note 14)

The display method described in Supplementary note 10 or 11, wherein

fading strength information indicating a fading strength is calculated, and

the received power, the cross-polarization discrimination information, and the fading strength information are displayed side by side in the outdoor apparatus.

(Supplementary Note 15)

The display method described in any one of Supplementary notes 9 to 14, wherein the received power is displayed in the outdoor apparatus based on a condition satisfying a predetermined bit error rate defined for each combination of a modulation scheme and the received power.

What is claimed is:

1. A communication apparatus comprising:
an antenna configured to receive a radio wave from a station on the other end;
an indoor apparatus configured to calculate propagation-path information about a condition of a propagation path by using the radio wave received by the antenna; and
an outdoor apparatus disposed near the antenna and configured to display received power and the calculated propagation-path information.

2. The communication apparatus according to claim 1, wherein
the indoor apparatus calculates cross-polarization discrimination information indicating cross-polarization discrimination, and
the outdoor apparatus displays the cross-polarization discrimination information.

3. The communication apparatus according to claim 2, wherein the outdoor apparatus displays the cross-polarization discrimination information in such a manner that a way of expression of the cross-polarization discrimination information changes according to magnitude of the cross-polarization discrimination indicated thereby.

4. The communication apparatus according to claim 1, wherein
the indoor apparatus calculates fading strength information indicating a fading strength, and
the outdoor apparatus displays the fading strength information.

5. The communication apparatus according to claim 4, wherein the outdoor apparatus displays the fading strength information in such a manner that a way of expression of the fading strength information changes according to magnitude of the fading strength indicated thereby.

6. The outdoor apparatus according to claim 2, wherein
the indoor apparatus calculates fading strength information indicating a fading strength, and
the outdoor apparatus displays the received power, the cross-polarization discrimination information, and the fading strength information side by side.

7. The communication apparatus according to claim 1, wherein the outdoor apparatus displays the received power based on a condition that satisfies a predetermined bit error rate defined for each combination of a modulation scheme and the received power.

8. A communication system comprising:
a communication apparatus comprising:
an antenna configured to receive a radio wave from a station on the other end;
an indoor apparatus configured to calculate propagation-path information about a condition of a propagation path by using the radio wave received by the antenna; and
an outdoor apparatus disposed near the antenna and configured to display received power and the calculated propagation-path information; and
the station on the other end configured to transmit the radio wave toward the communication apparatus.

9. A display method comprising:
calculating propagation-path information about a condition of a propagation path by using a radio wave received by an antenna, the antenna being configured to receive the radio wave from a station on the other end; and
displaying received power and the calculated propagation-path information in an outdoor apparatus disposed near the antenna.

10. The display method according to claim 9, wherein
cross-polarization discrimination information indicating cross-polarization discrimination is calculated, and
the cross-polarization discrimination information is displayed in the outdoor apparatus.

11. The display method according to claim 10, wherein the cross-polarization discrimination information is displayed in the outdoor apparatus in such a manner that a way of expression of the cross-polarization discrimination information changes according to magnitude of the cross-polarization discrimination indicated thereby.

12. The display method according to claim 9, wherein
fading strength information indicating a fading strength is calculated, and
the fading strength information is displayed in the outdoor apparatus.

13. The display method according to claim 12, wherein the fading strength information is displayed in the outdoor apparatus in such a manner that a way of expression of the fading strength information changes according to magnitude of the fading strength indicated thereby.

14. The display method according to claim 10, wherein
fading strength information indicating a fading strength is calculated, and
the received power, the cross-polarization discrimination information, and the fading strength information are displayed side by side in the outdoor apparatus.

15. The display method according to claim 9, wherein the received power is displayed in the outdoor apparatus based on a condition satisfying a predetermined bit error rate defined for each combination of a modulation scheme and the received power.
